(19) United States
(12) Patent Application Publication
(10) Pub. No.: US 2024/0359117 A1
(43) Pub. Date: Oct. 31, 2024

(54) RADIAL PLEATS FOR A FILTER

(71) Applicant: Pentair PLC, London (GB)

(72) Inventors: Abhilash Shishodia, Gautam Buddh Nagar (IN); Sunil Verma, Faridabad (IN); Girish Sharma, Greater Noida West (IN)

(21) Appl. No.: 18/684,737

(22) PCT Filed: Aug. 19, 2022
(86) PCT No.: PCT/IB2022/000551

§ 371 Date: Feb. 19, 2024

Related U.S. Application Data
(60) Provisional application No. 63/260,434, filed on Aug. 19, 2021.

(51) Int. Cl. B01D 29/21; B01D 46/52

(52) U.S. Cl. CPC B01D 29/213; B01D 46/521; B01D 2201/12

(57) ABSTRACT

A filter is provided. The filter comprises a plurality of radial pleats. Each of the plurality of radial pleats comprises a first section in a first plane and a second section in a second plane. Further, the first plane is offset with respect to the second plane.

### CROSS-REFERENCE TO RELATED APPLICATIONS

This application claims the benefit of U.S. Provisional Application Ser. No. 63/260,434, filed Aug. 19, 2021, the contents of which are hereby incorporated by reference in its entirety for all purposes.

### TECHNICAL FIELD

This disclosure generally relates to filters. More particularly, the invention relates to the radial pleats of a filter.

### BACKGROUND

Filters are used in many equipment or devices such as water filtering equipment, air filters, liquid filters, industrial filters, etc. A “filter,” as used herein, is an apparatus for filtering or removing unwanted materials and particles from fluids, oils, liquids, or gasses passing through the filter.

One type of conventional filter includes a filter having axial pleats. Generally, axial pleats are oriented parallel to a filter element installed in the filter. One of the drawbacks of axial pleat filters is that the raw media volume may not be completely utilized. Further, the surface area per element of the axial pleats may be relatively small compared to other filter types. The small surface area per element of the axial pleats may result in a lower fluid flow rate and subsequently results in shorter filter life. Moreover, the dirt holding capacity per element of the axial pleats may be less than other filter types.

In some conventional filters, the pleats are formed manually and are produced without using any automated processes or machines. Manually formed pleats may have a small surface area per element, offer less dirt holding capacity per element, and under-utilize available media volume for pleating. Thus, manually formed pleats may have a short life span.

Therefore, there is a need for a pleated filter that utilizes more of the media volume, increases the surface area per element, and has a high dirt holding capacity per element.

### SUMMARY

A filter is provided. In one embodiment, the filter comprises a plurality of radial pleats, each radial pleat of the plurality of radial pleats comprising a first section in a first plane, and a second section in a second plane and wherein the first plane is offset to the second plane.

In another embodiment, a filter comprises a first portion, a second portion, an element positioned between the first portion and the second portion, and a core positioned inside the element. The element comprises a pleated media and the pleated media is folded around the core.

In another embodiment, a filter comprises a plurality of radial pleats, each radial pleat of the plurality of radial pleats comprising a plurality of crests and a plurality of troughs. The plurality of troughs are positioned in the first plane and the plurality of crests are positioned in a second plane positioned above the first plane.

In one embodiment, the first section and the second section are parallel to each other.

In one embodiment, the first section corresponds to an outer diameter of each of the plurality of radial pleats.

In one embodiment, the second section corresponds to an inner diameter of each of the plurality of radial pleats.

In one embodiment, the first section has a fixed first circumference and the second section has a variable second circumference.

In one embodiment, the second circumference is about ⅕ to about ⅔ the size of the first circumference.

In one embodiment, each radial pleat of the plurality of radial pleats comprises a crest and a trough.

In one embodiment, the crest of each radial pleat of the plurality of radial pleats is in the second plane, and the trough of each radial pleat of the plurality of radial pleats is in the first plane.

In one embodiment, the crest and the trough of a first radial pleat of the plurality of radial pleats adjoin the crest and the trough of a second radial pleat of the plurality of radial pleats.

In one embodiment, the first portion is a filter cap.

In one embodiment, the first portion comprises a handle.

In one embodiment, the second portion is an end cap. The second portion is connected to a tube sheet that houses the element.

In one embodiment, the pleated media is attached to each of the first portion and the second portion.

In one embodiment, the plurality of crests and the plurality of troughs have an angular shape.

In one embodiment, the plurality of crests and the plurality of troughs have a wavy shape.

In one embodiment, a bottom of a first pleat of the plurality of radial pleats is joined to a top of a second pleat of the plurality of radial pleats to form a stack.

In one embodiment, the plurality of crests and the plurality of troughs of the first pleat align with the plurality of crests and the plurality of troughs of the second pleat.

In one embodiment, each of the plurality of radial pleats is produced by loading a media onto a mandrel, axially moving one or more plates including one or more blades onto the mandrel, and enabling the one or more blades to shape the loaded media to produce the plurality of radial pleats.

### DESCRIPTION OF THE DRAWINGS

FIG. 1 is a front elevational view of a filter comprising radial pleats according to an embodiment;

FIG. 2A is a side isometric view of the filter of FIG. 1;

FIG. 2B is a cross-sectional view of the filter of FIG. 2A;

FIG. 3 is an isometric view of a pleated media having radial pleats according to an embodiment;

FIG. 4A is a sectional view of radial pleats according to an embodiment;

FIG. 4B is a top isometric view of the radial pleats of FIG. 4A;

FIG. 4C is a side elevational view of the radial pleats of FIG. 4A;

FIG. 4D is a bottom elevational view of the radial pleats of FIG. 4A;

FIG. 4E is an isometric view of the radial pleats of FIG. 4A;

FIG. 5A is a sectional view of radial pleats according to another embodiment;

FIG. 5B is a top isometric view of the radial pleats of FIG. 5A;

FIG. 5C is a side elevational view of another embodiment of radial pleats;

FIG. 5D is a bottom elevational view of the radial pleats of FIG. 5C;

FIG. 5E is an isometric view of the radial pleats of FIG. 5C;

FIG. 6A is a side isometric view of a partially compressed pleated media according to an embodiment;

FIG. 6B is a side isometric view of an uncompressed pleated media of FIG. 6A;

FIGS. 7A-7C depict manufacturing steps to make radial pleats from a media;

FIG. 8A is a top elevational view of a blade used in the manufacturing of radial pleat;

FIG. 8B is a top elevational view of a blade used in the manufacturing of radial pleats; and

FIG. 8C is a top isometric view of another blade used in the manufacturing of radial pleats.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including” “comprising,” or “having” and variations thereof herein is meant to encompass the items listed thereafter and equivalents thereof as well as additional items. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step, or procedure, excepting those that are not essential to operability. The term “consisting of” excludes any component, step, or procedure not specifically delineated or listed. Unless specified or limited otherwise, the terms “mounted,” “connected,” “supported,” and “coupled” and variations thereof are used broadly and encompass both direct and indirect mountings, connections supports, and couplings. Further, “connected” and “coupled” are not restricted to physical or mechanical connections or couplings. The term “or,” unless stated otherwise, refers to the listed members individually as well as in any combination. Use of the singular includes use of the plural and vice versa.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from the embodiments of the invention. Thus, embodiments of the invention are not intended to be limited to embodiments shown but are to be accorded the widest scope consistent with the principles and features disclosed herein. The following detailed description is to be read with reference to the FIG.s, in which like elements in different FIG.s have like reference numerals. The FIG.s, which are not necessarily to scale, depict selected embodiments and are not intended to limit the scope of embodiments of the invention. Skilled artisans will recognize the examples provided herein have many useful alternatives and fall within the scope of embodiments of the invention.

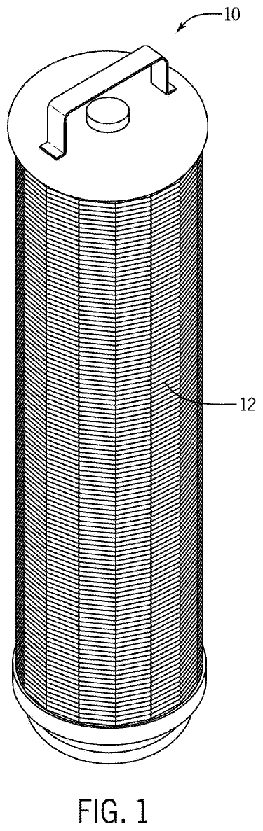

Referring now to FIG. 1, a filter 10 is shown. As shown, the filter 10 comprises an elongate filter element 12 which comprises pleated media, which is explained in more detail below. In some embodiments, the filter 10 is used for the separation of particles from fluid, liquid oil, gas, and the like. In some embodiments, the filter 10 is applicable in several industries or fields such as the oil and gas industry, automobile industry, and any other industry as applicable.

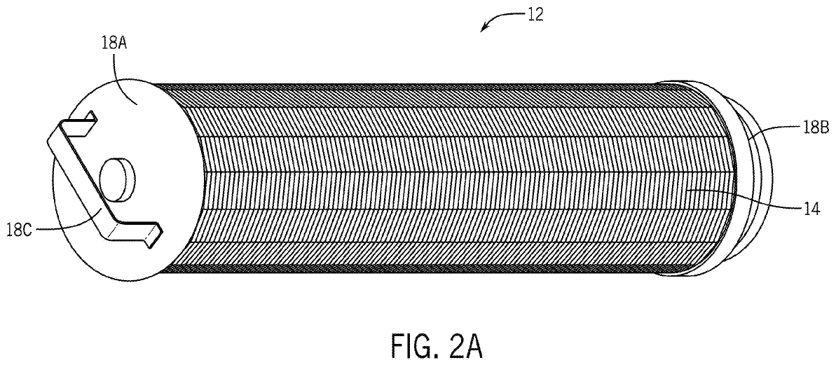

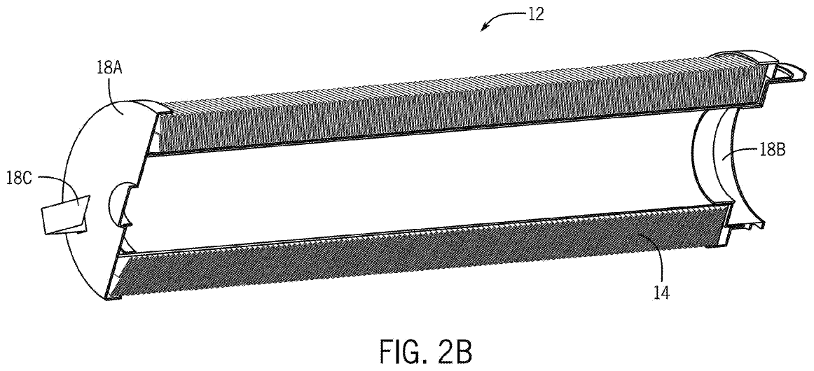

FIG. 2A illustrates a side isometric view of the filter element 12 of FIG. 1 having a pleated media 14. The pleated media 14 is disposed around the element 12 and extends from a first end to a second end. FIG. 2B illustrates a cross-sectional view of the filter clement 12 of FIG. 2A. In this cross-sectional view, the pleated media 14 can be seen only at two parallel ends as there is a hollow space in the center extending longitudinally through the element to accommodate the core.

The filter element 12 may comprise a first portion 18A at the first end, the pleated media 14, and a second portion 18B at the second end. As shown, the filter element 12 may be provided in the form of a cylinder. However, it is to be understood that the filter element 12 may be provided as a hexagonal shape or any other similar shape. In some embodiments, a core (not shown) may be included inside the filter element 12. Around the core, the pleated media 14 may be wrapped or folded. The core may help in retaining the shape of the pleated media 14.

The pleated media 14 may be attached to the first portion 18A of the filter element 12 on the first end. Further, the first portion 18A may act as a cover (or a closed end cap) of the filter element 12. The first portion 18A may further comprise a handle 18C protruding outwardly therefrom. The first portion 18A may be provided as a material such as steel, nylon, and/or polypropylene and the like depending upon the intended use.

The second portion 18B of the filter element 12 may include one or more threads. The pleated media 14 may be attached to the second portion 18B of the filter element 12 at the second end. The second portion 18B may be provided as an open end cap and may be connected to a tube sheet for holding/housing the filter element 12. Similar to the first portion 18A, the second portion 18B may be made provided as a material such as steel, nylon, and/or polypropylene and the like depending upon the intended use.

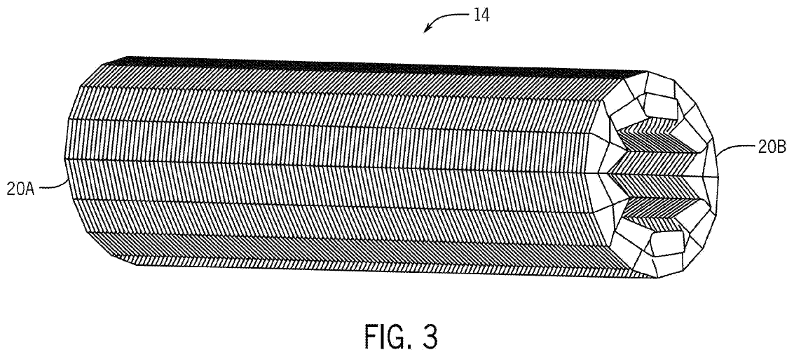

Referring now to FIG. 3, a side isometric view of the pleated media 14 is shown. As illustrated, the pleated media 14 may be defined by a first portion 20A and a second portion 20B. The first portion 18A of the filter element 12 of FIGS. 2A-B may be attached to the first portion 20A of the pleated media 14. Similarly, the second portion 18B of the filter element 12 of FIGS. 2A-B may be attached to the second portion 20B of the pleated media 14. The pleated media 14 may be provided in the form of polypropylene and the like. The pleated media 14 may be a cylindrical shape, a hexagonal shape, or any other similar shape. Further, the pleated media 14 may include a hollow block permitting the pleated media 14 to be attached to a tube sheet.

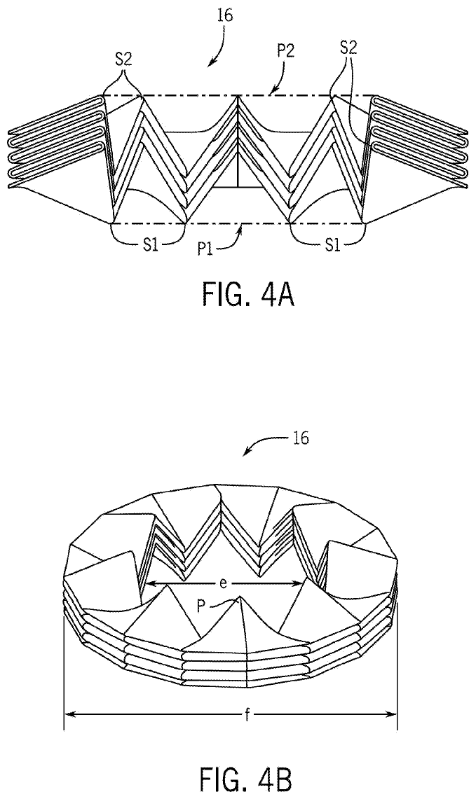

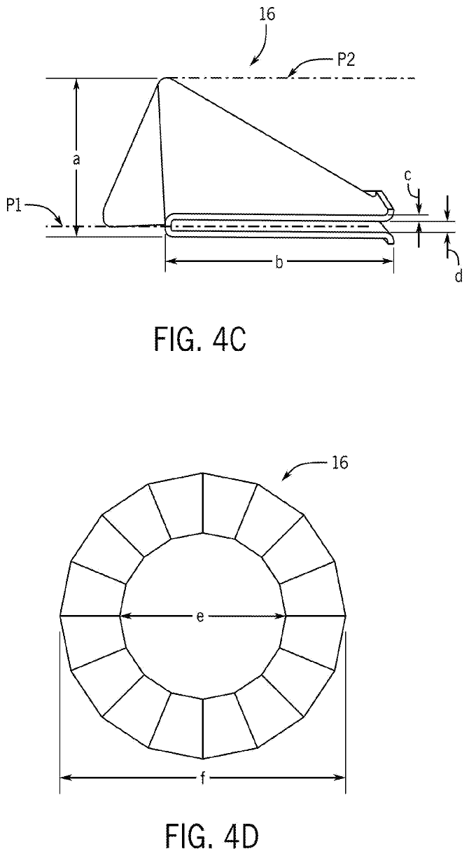

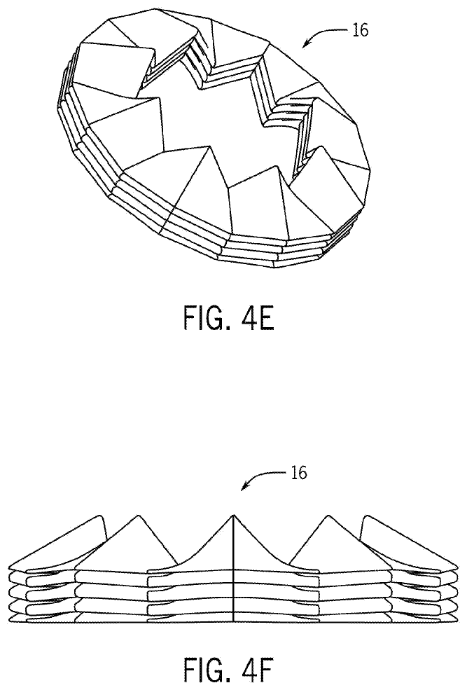

Referring now to FIGS. 4A-F, the pleated media 14 is provided in the form of a plurality of radial pleats 16. The plurality of radial pleats 16 may be arranged in the filter 10 in such a manner that each pleat of the plurality of radial pleats 16 is perpendicular to the filter 10 (not shown). The plurality of radial pleats 16 may be made of a material such as polypropylene and the like. Each radial pleat of the plurality of radial pleats 16 is defined by a crest and a trough. As depicted, the first crest and the first trough of one radial pleat may adjoin a second crest and a second trough of an adjacent radial pleat.

The trough of each pleat of the plurality of radial pleats 16 may be parallel to and touching a first plane P1. The crest of each pleat of the plurality of radial pleats 16 may be parallel and terminate at a second plane P2. The first plane P1 may be parallel to and touching a flat surface such as the ground, or a bottom surface of a reference section. The portion of the radial pleats 16 that intersects the first plane P1 may be referred to as a first section S1.

In one embodiment, the second plane P2 may be positioned above the first plane P1. The portion of the radial pleats 16 that touches the second plane P2 may be referred to as a second section S2. Because the first plane P1 is at the ground, bottom, or reference section, and the second plane P2 is above the ground, bottom, or reference section, the first plane P1 is offset with respect to the second plane P2. In this way, each of the plurality of radial pleats 16 is provided as a three-dimensional radial pleat.

The first section S1 may be defined by an outer dimension f (e.g., outer diameter), and the second section S2 may be defined by an inner dimension e (e.g., inner diameter). The outer dimension f and the inner dimension e may be parallel to each other. In other words, the second section S2 (i.e. inner dimension e) is surrounded by the first section S1 (outer dimension f). Thus, the first section S1 (outer dimension f) and the second section S2 (i.e. inner dimension e) are concentric.

In another embodiment, the first section S1 and the second section S2 may not be parallel to each other as the second section S2 may have a curvy or wavy crest and trough. As shown in FIGS. 4E and 4F, the second section S2 (i.e. inner dimension e) is surrounded by the first section S1 (outer dimension f), which is offset with respect to each other due to the curvy/wavy crests and troughs.

Each of the radial pleats of the plurality of radial pleats 16 may have a thickness of about 0.025 inches. There may be a gap between each pleat of the plurality of radial pleats 16 of about 0.050 inches. It is to be understood that the gaps between each pleat can vary depending on the embodiment. Further, the thickness of the plurality of radial pleats 16 may depend upon raw media material and may be provided between about 0.001 inches to about 0.05 inches, or more.

Referring specifically to FIG. 4B, an isometric view of the plurality of radial pleats 16 is shown. A compressed pleated media comprising the plurality of radial pleats 16 is shown. In this view, it can be seen that the first section S1 is defined by the outer dimension f. The outer dimension f of each of the plurality of radial pleats 16 in the first plane P1 may be defined as the distance between the outermost sides of the first section S1 of the plurality of radial pleats 16 which is adjacent to or touches the ground or bottom section. The second section S2 may be defined by the inner dimension e defined as the distance between the peaks p formed by a crest of each of the plurality of radial pleats 16 in the second plane P2. The peaks p may not touch the ground or bottom section.

In one embodiment, the first section S1 has a fixed circumference and the second section S2 has a variable circumference. In other words, the dimension of the first section S1 (i.e. outer dimension f) cannot be varied and has a fixed dimension. Further, the dimension of the second section S2 (i.e. inner dimension e) is variable and can be changed or varied. Table 1, below, illustrates example dimensions.

TABLE 1

| Outer Dimension | Inner Dimension | Height of | Length of |
|---|---|---|---|
| (f) (in) | (e) (in) | Pleat (in) | pleat (in) |
| 6 | 4 | 0.74 | 1 |
| | 3.5 | 0.84 | 1.25 |
| | 3 | 0.92 | 1.5 |
| 5 | 3 | 0.69 | 1 |
| | 2.5 | 0.77 | 1.25 |
| | 2 | 0.84 | 1.5 |
| 4 | 2 | 0.62 | 1 |
| | 1.5 | 0.68 | 1.25 |
| | 1 | 0.72 | 1.5 |

As explained above, the first section S1 (outer dimension f) may have a fixed circumference, thus, the value of the outer dimension f can be fixed at about 6 inches, about 5 inches, or about 4 inches. When the value of the outer dimension f is provided at about 6 inches, the value of the second section S2 (i.e. inner dimension e) can be varied from about 4 inches to about 3 inches. Similarly, when the value of the outer dimension f is provided at about 5 inches, the value of the second section S2 (i.e., inner dimension e) can be varied between about 3 inches to about 2 inches. Likewise, when the value of the outer dimension f is provided at about 4 inches, the value of the second section S2 (i.e., inner dimension e) can be varied between about 2 inches to about 1 inch. It is to be noted herein that the values provided in Table 1 are exemplary and any other variations in these values are within the scope of this invention.

Referring specifically to FIG. 4C, each pleat of the plurality of radial pleats 16 may be defined by a height a, a length b, a thickness c, and a gap d. The height a may be between about 0.5 inches to about 1.5 inches, or about 0.6 inches to about 1.2 inches, or about 0.7 inches to about 1 inch. The length b may be between about 0.5 inches to about 1.5 inches, or about 0.75 inches to about 1.3 inches, or about 1 inch to about 1.2 inches. The thickness c may be between about 0.1 inches to about 0.75 inches, or about 0.15 inches to about 0.4 inches, or about 0.2 inches to about 0.3 inches. The gap d may be between about 0.1 inches to about 1 inch, or about 0.3 inches to about 0.7 inches, or about 0.4 inches to about 0.6 inches. As an example, the pleat 16 may have a height a of about 0.78 inches, a length b of about 1 inch, a thickness c of about 0.25 inches, and a gap d of about 0.50 inches.

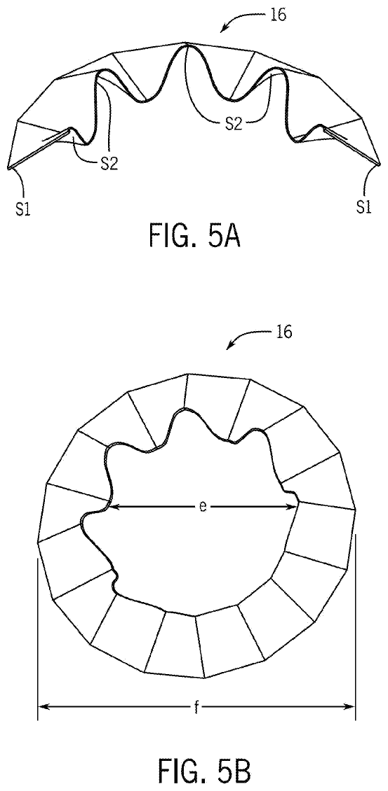

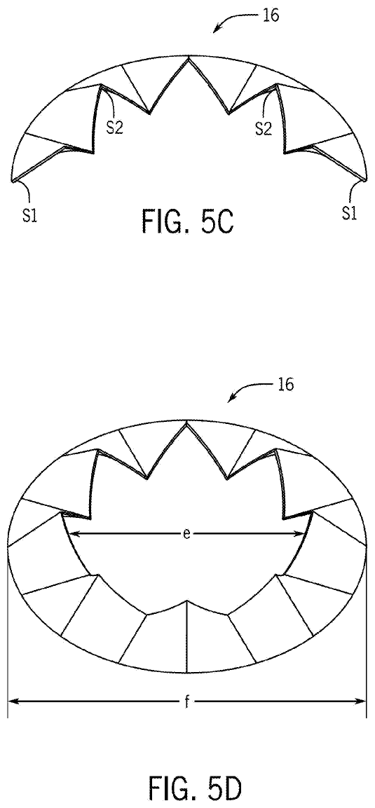

Referring now to FIGS. 5A-D, various views of radial pleats 16 are shown according to another embodiment. Similar to FIGS. 4A-F, the radial pleats 16 may comprise a first section S1 in a first plane and a second section S2 in a second plane. Here, the first plane is offset to the second plane. The first plane is positioned touching the ground, or a bottom reference section and the second plane is positioned above the first plane (i.e., the second plane does not touch the ground or bottom reference section).

FIGS. 5A and 5B depict a radial pleat having curved or wavy crests and troughs (i.e., no sharp edges). FIGS. 5C-5D depict a radial pleat having sharp or pointy crests and troughs.

As can be seen in FIGS. 5B and 5D, each embodiment (i.e., the radial pleat having curvy or wavy crests and troughs of FIGS. 5A-B and the radial pleat having sharp or pointy crests and troughs of FIGS. 5C-D) the first section S1 corresponds to an outer dimension f (e.g., diameter) of the radial pleat, and the second section S2 corresponds to an inner dimension e (e.g., diameter) of the radial pleat 16. The inner dimension e of the radial pleat 16 is defined by the distance between each crest. The outer dimension f of the radial pleat 16 is defined by the distance between each trough. The outer dimension f, the inner dimension e, the height, and the length of the radial pleat shown in FIGS. 5A-5D can be varied as per the dimensions provided in Table 1 above.

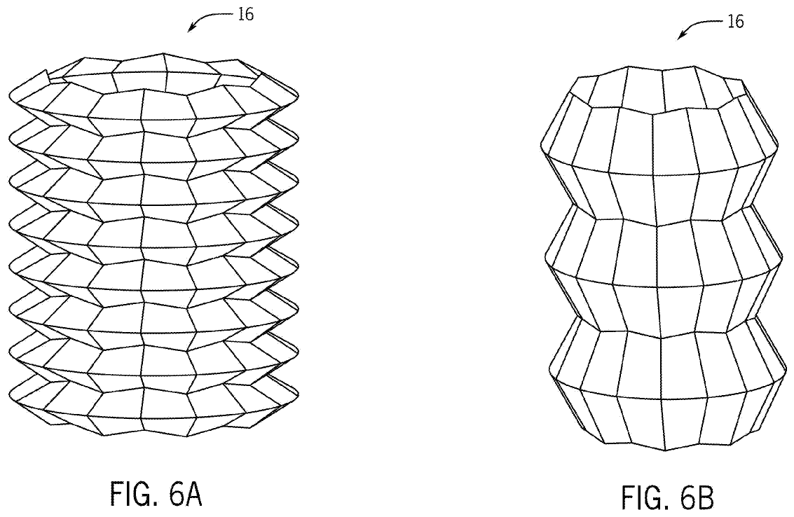

Referring now to FIGS. 6A-B, a partially compressed pleated media comprising the plurality of radial pleats 16 is shown. In FIG. 6A, the plurality of radial pleats are shown in a compressed form, and in FIG. 6B the plurality of radial pleats is shown in an uncompressed form. The plurality of radial pleats 16 may be the radial pleats of FIGS. 4A-4F or the radial pleats of FIGS. 5A-5D. The plurality of radial pleats 16 may be the pleated media 14 of FIGS. 2A-2B and FIG. 3.

A plurality of radial pleats, as discussed in the above embodiments, may have an increased per clement capacity to retain dirt and other unwanted contaminants due to an increased per element surface area as compared to existing axial pleat designs. Additionally, more of the media volume may be utilized with this kind of radial pleat design, which may result in the radial pleat design having a longer life as compared to axial pleats or other known pleats.

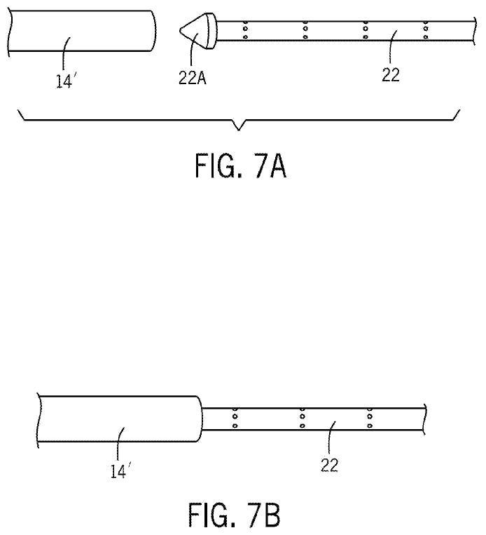

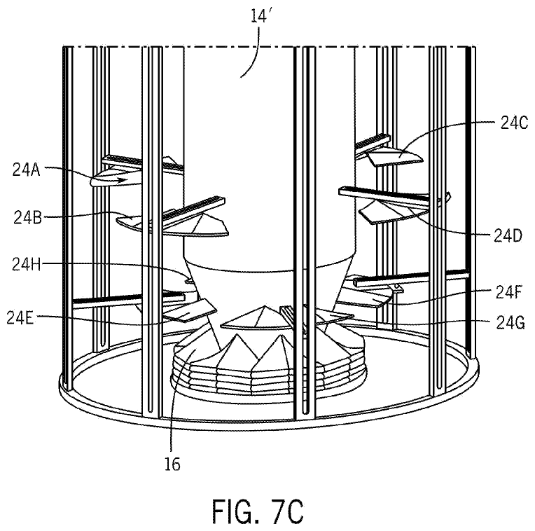

Referring now to FIGS. 7A and 7B, manufacturing of the plurality of radial pleats 16 from a raw media 14′ are shown. A mandrel 22 having a triangular or conical shaped head 22A is inserted into a raw media 14′ having a hollow cylindrical shape. The mandrel 22 may have a plurality of holes through which the air is circulated and thereby, retains the raw media 14′ in the cylindrical shape during the manufacturing process described in more detail below. As the raw media 14′ is entirely loaded onto the mandrel 22, the raw media 14′ completely surpasses the head 22A of the mandrel 22.

FIG. 7C illustrates a first set of upper blades 24A-24D and a second set of lower blades 24E-24H used in the manufacturing of the plurality of radial pleats 16. Although two sets of blades (each having four blades) are shown herein, it is understood for a person skilled in the art that any number of sets of blades with any number of blades can be used.

As shown, the one or more blades 24A-24H are connected to a respective rod. First, plates including the first set of upper blades 24A-24D and the second set of lower blades 24E-24H are axially moved onto a mandrel, such as the mandrel 22 of FIGS. 6A-B, wherein the upper blades 24A-24D are positioned above the lower blades 24E-24H. The upper blades 24A-24D and the second set of lower blades 24E-24H may be in contact with the raw media 14′.

To form a pleat, the lower blades 24E-24H may be moved radially inward and down towards the raw media 14′. As the lower blades 24E-24H move downwards to the raw media 14′, the lower blades 24E-24H may fold or wrap the raw media 14′ to form a pleat. At this stage, the upper blades 24A-24D may remain in their original position. The pleat is formed or shaped based on the shape of the second set of lower blades 24E-24H.

Next, the upper blades 24A-24D may move radially inward and downward toward the raw media 14′ similar to the lower blades 24E-24H. At this instant, the upper blades 24A-24D are positioned above the lower blades 24E-24H. There may be a gap between the upper blades 24A-24D and the lower blades 24E-24H. The gap between the upper blades 24A-24D and the lower blades 24E-24H may depend upon the design of the pleats to be formed. As the first set of upper blades 24A-24D move in and down toward the raw media 14′, the upper blades 24A-24D fold or wrap the raw media 14′ to form a pleat. The pleat is formed or shaped based on the shape of the first set of upper blades 24A-24D.

After the pleat has been formed, the lower blades 24E-24H may be moved away from the raw media 14′ in a radially outward direction. Lastly, the upper blades 24A-24D may move down towards the end of the raw media 14′ to complete the formation of the pleat.

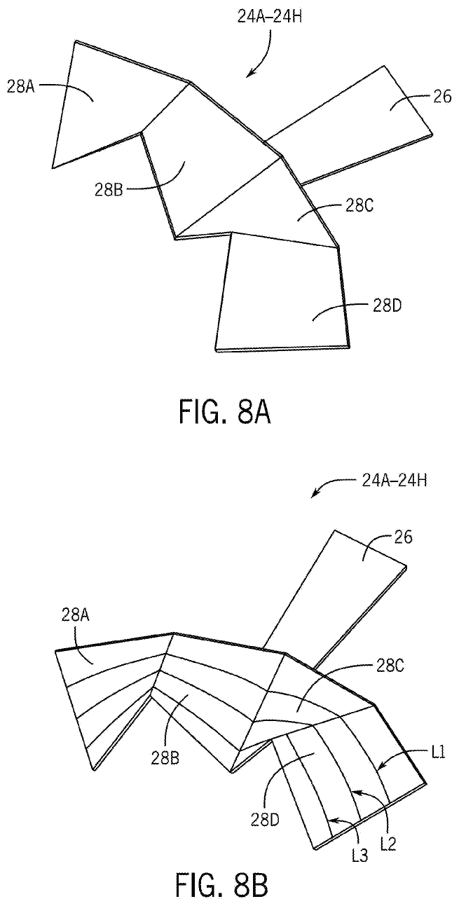

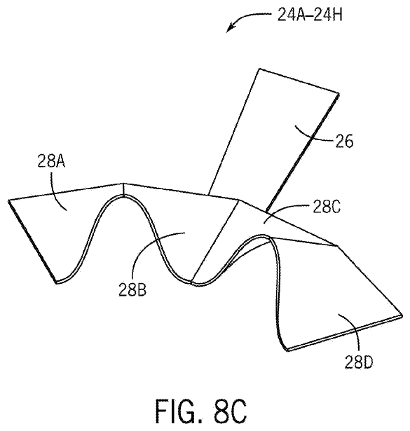

FIGS. 8A-C, illustrate various blade designs that may be the one or more blades 24A-24H of FIG. 7C. Each of the one or more blades 24A-24H may have a handle 26 and one or more fins 28A-28D. The handle 26 may be connected to a respective rod as shown and explained above in FIG. 7C. As can be seen, each of the one or more fins 28A-28D may have a pointed crest and trough (See FIGS. 8A-B) or a wavy crest and trough (See FIG. 8C) which forms the shape of each pleat.

In one embodiment, each of the one or more blades 24A-24H may have four fins/faces, namely, a first fin 28A, a second fin 28B, a third fin 28C, and a fourth fin 28D. Referring specifically to FIG. 8B, each of the one or more fins 28A-28D has three lines, namely, a first line L1, a second line L2 and a third line L3. When the raw media 14′ is shaped by the one or more blades 24A-24H, the raw media 14′ acquires the shape of the one or more blades 24A-24H. As such, during the manufacturing of the pleats, when the raw media 14′ is in contact with the first line L1, the raw media 14′ is circular. And, when the raw media 14′ is in contact with the third line L3, the raw media 14′ is wavy in shape.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A filter, comprising:
a plurality of radial pleats, each radial pleat of the plurality of radial pleats comprising:
a first section in a first plane; and
a second section in a second plane, the first plane being offset with respect to the second plane.

2. The filter of claim 1, wherein the first section and the second section are parallel with respect to each other.

3. The filter of claim 1, wherein the first section corresponds to an outer diameter of each of the plurality of radial pleats.

4. The filter of claim 1, wherein the second section corresponds to an inner diameter of each of the plurality of radial pleats.

5. The filter of claim 1, wherein the first section has a fixed first circumference and the second section has a variable second circumference.

6. The filter of claim 5, wherein the second circumference is about ⅕ to about ⅔ the size of the first circumference.

7. The filter of claim 1, wherein each radial pleat of the plurality of radial pleats comprises a crest and a trough.

8. The filter of claim 7, wherein the crest of each radial pleat of the plurality of radial pleats is in the second plane; and
wherein the trough of each radial pleat of the plurality of radial pleats is in the first plane.

9. The filter of claim 7, wherein the crest and the trough of a first radial pleat of the plurality of radial pleats adjoin the crest and the trough of a second radial pleat of the plurality of radial pleats.

10. The filter of claim 1, wherein each of the plurality of radial pleats is produced by:
loading a media onto a mandrel;
axially moving one or more plates including one or more blades onto the mandrel; and
enabling the one or more blades to shape the loaded media to produce the plurality of radial pleats.

11. A filter, comprising:
a plurality of radial pleats, each radial pleat of the plurality of radial pleats comprising:
a plurality of troughs positioned in a first plane; and
a plurality of crests positioned in a second plane above the first plane.

12. The filter of claim 11, wherein the plurality of crests and the plurality of troughs have an angular shape.

13. The filter of claim 11, wherein the plurality of crests and the plurality of troughs have a wavy shape.

14. The filter of claim 11, wherein a bottom of a first pleat of the plurality of radial pleats is joined to a top of a second pleat of the plurality of radial pleats to form a stack.

15. The filter of claim 11, wherein the plurality of crest and the plurality of troughs of the first pleat align with the plurality of crests and the plurality of troughs of the second pleat.
